(19) United States
(12) Patent Application Publication
(10) Pub. No.: US 2026/0281929 A1
(43) Pub. Date: Sep. 17, 2026

(54) METHOD OF SYNCHRONIZATION OF A WIRELESS SENSOR SYSTEM AND A SENSOR SYSTEM IMPLEMENTING SUCH A METHOD

(71) Applicant: MOVE S.P.A., Milano (MI) (IT)

(72) Inventors: Ferdinando Frediani, Lucca (LU) (IT); Gabriele Corsi, Sinalunga (SI) (IT); Marco Galli, Lucca (LU) (IT); Matteo Giorgi, Fucecchio (FI) (IT); Alessandro Rumbo, Altopascio (LU) (IT)

(21) Appl. No.: 18/875,722

(22) PCT Filed: Jun. 15, 2023
(86) PCT No.: PCT/IB2023/056216

§ 371 Date: Dec. 16, 2024

(30) Foreign Application Priority Data
Jun. 16, 2022 (IT) 102022000012779

(51) Int. Cl. H04W 56/00; H04W 4/38

(52) U.S. Cl. CPC H04W 56/0035; H04W 4/38; H04W 56/004

(57) ABSTRACT

Synchronization method (100) for a wireless sensor system (10) for monitoring civil structures comprising the steps: providing and arranging (101) a sensor system (10) on a civil structure, the sensor system (10) comprising: a plurality of sensors (11), each of the sensors (11) comprising a counting and timing device (13) and a peripheral processing and control unit (14), the counting and timing device (13) comprising an oscillator (15) capable of generating a clock signal at a predetermined oscillation frequency f_{c}, the peripheral processing and control unit (14) being configured to generate a clock signal having a frequency equal to a nominal sampling frequency fs, the oscillator having a nominal maximum tolerance δ_{fmn}; a central processing and control unit (12) configured to communicate with the sensors (11) wirelessly; calculating (102) the limit maximum tolerance of one of the oscillators (15) δ_{fml}; if δ_{fmn}≤_{fmi} performing a first-level synchronisation (200) comprising the steps: at an initial tuning instant equal to tₐ T_{diff} placing (201) the sensors (11) in a state of continuous reception for a time window having a duration greater than 2T_{diff}; at the monitoring start instant ta sending wirelessly (202) a single multicast monitoring start message addressed to all the sensors (11); receiving (203) via the sensors (11) the multicast monitoring start message; initiating (204) the sampling of the continuous time signal xₘ(t) at a sampling start instant t₀.

The present invention refers to a method of synchronization of a wireless sensor system, particularly but not exclusively employable in the field of monitoring of structures or civil works such as bridges, viaducts, buildings and so on.

The present invention also refers to a sensor system implementing the aforementioned method.

Nowadays it is known to monitor the status of a structure or civil works by preparing a system of sensors which are positioned in different points of the structure to be monitored. Such sensors can be vibration sensors, displacement sensors and so on.

It is known to configure such a sensor system according to a star configuration, i.e. by providing a centralized control device and a plurality of distributed sensors.

Modal analysis is widely used in the area of the monitoring of structures or civil works, which involves extrapolating the frequencies and mode shapes of the structure being examined and then studying the evolution thereof during its life cycle. To carry out this type of analysis, the first step is to simultaneously acquire, and in multiple points, the vibrations of the structure induced by environmental effects. Therefore, synchronous acquisition of detection data is necessary in this area. In fact, consider the case in which a plurality of M wireless sensors have been arranged in an area of a structure or civil work that must simultaneously acquire a certain quantity X.

Each sensor will observe a continuous time signal xₘ(t) which is then sampled. In this case, it would be desirable for all sensors to start sampling at a predetermined time to with a frequency fₛ thus obtaining for each sensor a sequence of n samples xₘ[t₀+n/fₛ]. In reality, it happens instead that each sensor starts sampling at an instant tₘ=t₀+δₜₘ and with a frequency fₘ=fₛ(1+δ_{fm}), obtaining sequences xₘ[t₀+δtₘ+n/(fₛ(1+δ_{fm}))] and therefore acquisition is not synchronized. Non-idealities linked to sampling dyssynchrony were modelled by means of a contribution δₜₘ representing a time error on the start of the sampling and a contribution δ_{fm} representing an error on the nominal sampling frequency. Both of these errors ultimately come from the uncertainty about the actual frequency of the oscillator of each sensor. Each sensor has in fact a time reference based on its own oscillator that is different to a certain extent from that of the others. In addition, each sensor has its own control unit programmed to start sampling the continuous time signal xₘ(t) at time to; such programming is not sufficient to guarantee synchronised acquisition precisely in light of the non-ideality of the oscillators of the individual sensors that results in the occurrence of the aforementioned errors.

In order to solve the problem related to the synchronous acquisition of the sensors it is known to arrange a wired connection between the centralized control device and each of the sensors of the sensor system. In this case, the centralized control device sends respective clock pulses to the sensors. The reception by the single sensor of the relative clock pulse results in the start of the sampling of the continuous time signal xₘ(t) under observation. In other words, the sampling of the sensors is synchronised thanks to these clock pulses being sent. This synchronisation methodology is not easily applicable to the case of wireless sensor systems because such sensors communicate using radio protocols which as is known do not guarantee a known and constant response latency especially in scenarios where it is necessary to send numerous data packets. In addition, in many protocols there are limits on the transmission duty cycle, so depending on the desired acquisition frequency it is not guaranteed that it is possible to send sufficiently close sampling pulses.

The article by Bing Jang et al: “A clock drift compensation method for synchronous sampling in sensor networks”, Measurement Science and Technology, IOP, Bristol, GB, vol. 30, no. 2, 17 Jan. 2019, page 25103 describes a clock drift compensation method for synchronous samplings.

The object of the present invention is to obviate the aforementioned drawbacks and in particular to devise a synchronisation method that is capable of synchronising a wireless sensor system in a sufficiently accurate manner for the application scenario considered.

Another object of the present invention is to realize a sensor system that implements the aforementioned synchronisation method.

This and other objects according to the present invention are achieved by realizing a synchronisation method of a wireless sensor system as set forth in claim 1 and a sensor system as set forth in claim 5.

Further features of the synchronisation method of a wireless sensor system and of the sensor system are the subject-matter of the dependent claims.

The features and the advantages of a synchronisation method of a wireless sensor system and of the sensor system according to the present invention will become more apparent from the following exemplary and non-limiting description of the accompanying schematic drawings in which:

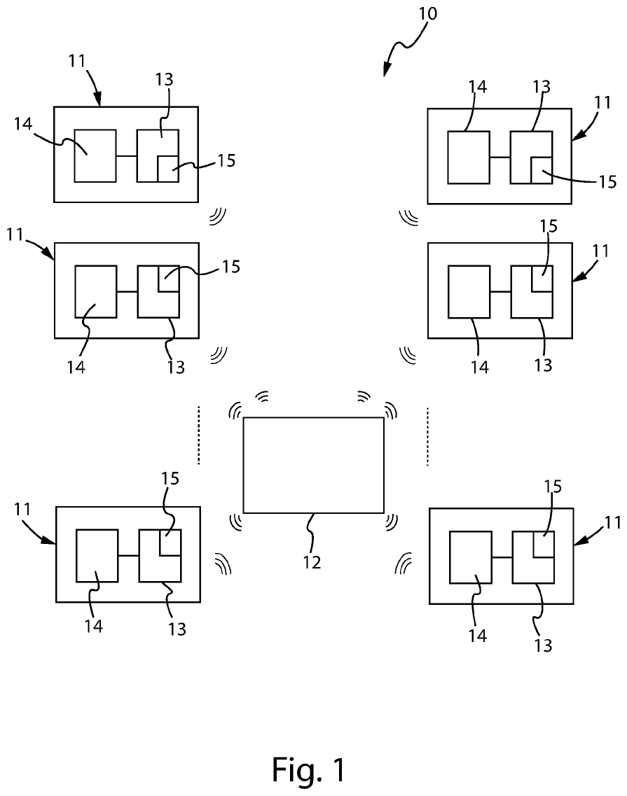

FIG. 1 is a schematic block view of a sensor system according to the present invention;

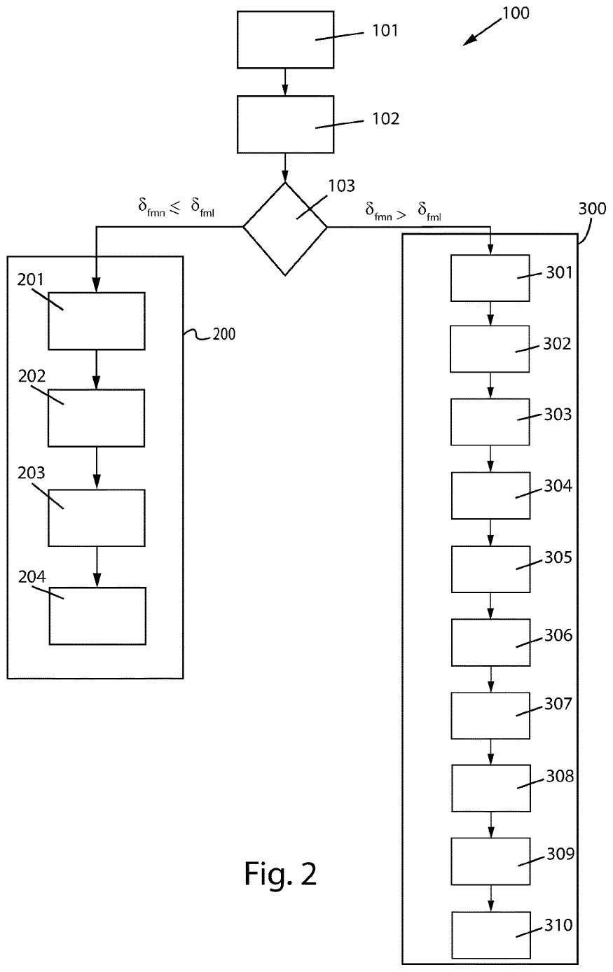

FIG. 2 is a flowchart depicting the synchronisation method according to the present invention.

With reference to the figures, a wireless sensor system for the monitoring of civil structures is shown, overall indicated with 10.

Such a sensor system 10 comprises a plurality of sensors 11 configured to communicate wirelessly and a central processing and control unit 12, for example a terminal such as a personal computer or a server and so on, configured to communicate with the sensors 11 wirelessly. The sensors 11 are equal to M in number and are indicated with an order number m ranging from 1 to M.

In the present discussion, the term “to communicate wirelessly” is intended to indicate the capacity to transmit and receive data over a wireless connection in accordance with any wireless communication protocol, for example the so-called LoRa protocol.

The sensors 11 are in particular suitable for detecting quantities useful for monitoring civil structures, for example they are vibration or displacement sensors.

Each sensor 11 comprises a counting and timing device 13 and a peripheral processing and control unit 14, for example a microprocessor, associated with said counting and timing device 13; moreover, the maximum possible offset T_{diff} between the counting and timing devices 13 of the sensors 11 is known. Each sensor is also configured to detect and sample a continuous time signal xₘ(t) wherein m indicates the m-th sensor 11. The sampling of the continuous time signal xₘ(t) takes place at a nominal sampling frequency fₛ determined by the frequency of a clock signal generated by the counting and timing device 13. The counting and timing device 13 comprises, in fact, an oscillator 15 capable of generating a clock signal at a predetermined oscillation frequency f_{c}; the peripheral processing and control unit 14 is configured to operate on the counting and timing device 13 to generate a clock signal having a frequency equal to the nominal sampling frequency fₛ based on a predetermined relationship between the predetermined oscillation frequency f_{c} and the nominal sampling frequency fₛ.

Preferably the sensors 11 are configured to vary their sampling frequency fₛ. In this case, the peripheral processing and control unit 14 of each sensor 11 comprises a timing register rₘ whose value is variable and may be set by the peripheral processing and control unit 14. The counting and timing device 13 is configured to generate from the clock signal at the oscillation frequency f_{c} a clock signal at a frequency which depends on the value of the timing register rₘ. The oscillator of the counting and timing device 13 of the m-th sensor has a nominal maximum tolerance δ_{fmn}.

In detail, the communication between the central processing and control unit 12 and the sensors 11 can take place according to a wireless communication protocol according to which the sensors 11 are configured to assume for a predetermined time range a state of continuous reception during which they can receive data. Furthermore, such wireless communication protocol supports multicast functionality i.e. it allows to simultaneously transmit multicast messages from the central processing and control unit 12 to the sensors 11.

Preferably the central processing and control unit 12 is provided with an accurate time reference with respect to the desired synchronisation needs. For example, the central processing and control unit 12 can be equipped with a GPS reference that allows performing a very accurate time synchronisation, or with a very accurate reference oscillator, such that the maximum time offset with respect to the absolute time is much lower than T_{diff}i.e. at least two orders of quantity lower than T_{diff}.

The synchronisation method 100 according to the present invention is implementable by the above-described sensor system 10 and will be described below.

Consider first that each sensor 11 starts sampling at an instant tₘ=t₀+δtₘ and with a frequency fₘ=fₛ (1+δ_{fm}) wherein to is the nominal sampling start instant, δₜₘ indicates a time error on the start of the sampling and fₛ is the nominal sampling frequency, δ_{fm} indicates an error on the nominal sampling frequency and is the maximum tolerance of the oscillator of the counting and timing device 13 of the m-th sensor. The unsynchronised signal sequence sampled by the m-th sensor is xₘ[t₀+δtₘ+n/(fₛ(1+δ_{fm}))].

The nominal duration of the sampling window is indicated with T_{c} and with k the number of samples to be acquired in that sampling window and with fₛ the nominal sampling frequency; these quantities are linked by the following expression T_{c}=k/fₛ.

The duration of the real sampling window of the m-th sensor is instead obtained from the following expression T_{cm}=k/(fₛ (1+δ_{fm})) which takes into account the non-ideality of the sampling frequency.

Thus the time offset δₜ at the end of the sampling window is given by the following expression δₜ=T_{c}−T_{cm}=k/fₛ−k/(fₛ(1+δ_{fm})).

It is indicated with τ_{d} the maximum predetermined synchronisation error that one decides to tolerate in a given application.

For example, the maximum predetermined synchronisation error τ_{d} may be at least 100 times smaller than the minimum oscillation period corresponding to the maximum modal frequency typical of the civil structure to be monitored.

For example consider the case where the civil structure has three vibration modes, a first vibration mode at the frequency of 1 Hz corresponding to a period T₁=1 s, a second vibration mode at the frequency of 5 Hz corresponding to a period T₂=200 ms, a third vibration mode at the frequency of 10 Hz corresponding to a period T₃=100 ms. In this case, the maximum predetermined synchronisation error τ_{d} equal to T₃/100=1 ms is set.

In this case, it is necessary for the time offset δₜ to be smaller than the predetermined maximum tolerable synchronisation error τ_{d}, that is, it is necessary that τ_{d}>δₜ.

The boundary condition is that at which the time offset δₜ is equal to the predetermined maximum tolerable synchronisation error τ_{d}. Therefore, by placing τ_{d}=δₜ it is obtained that δ_{fml}=(τ_{d}·fₛ)/(k−(τ_{d}·fₛ)) wherein δ_{fml} indicates the limit maximum tolerance of the oscillator of the counting and timing device 13 of the m-th sensor. Based on the maximum nominal tolerance available of the oscillator, and on other design data, it can be verified in a first case that δ_{fmn}≤δ_{fml} and then δ_{fmn}≤(τ_{d}·fₛ)/(k−(τ_{d}·fₛ)) or in a second case that δ_{fmn}>δ_{fml} and thus δ_{fmn}>(τ_{d}·fₛ)/(k−(τ_{d}·fₛ)).

The first case corresponds to the case in which δₜ≤τ_{d}; in this case all the samples k acquired have a desynchronisation smaller than τ_{d}, so for the application being examined they can be considered as synchronised.

The second case corresponds to the case in which δₜ>τ_{d}; in this case some of the k-samples acquired have a desynchronisation greater than τ_{d} and therefore the acquisitions cannot be considered as synchronised.

The synchronisation method 100 first comprises the step in which the sensor system 10 is provided and it is arranged 101 on a civil structure.

Then the limit maximum tolerance of the oscillator δ_{fml} is calculated 102 on the basis of the nominal sampling frequency fₛ, the predetermined maximum tolerable synchronisation error τ_{d} and the number of samples to be acquired in a sampling window T_{c} at said nominal sampling frequency fₛ.

Next, it is provided for the step in which the nominal maximum tolerance δ_{fmn} is compared 103 with the previously calculated limit maximum tolerance δ_{fml}.

If δ_{fmn}≤δ_{fml} the synchronisation method 100 envisages performing a first-level synchronisation 200 comprising the steps of:
at an initial tuning instant equal to tₐ−T_{diff}, placing 201 the sensors 11 in a state of continuous reception for a continuous reception time window having a duration greater than 2T_{diff} wherein tₐ indicates the monitoring start instant;
at the monitoring start instant tₐ sending 202 wirelessly via the central processing and control unit 12 a single multicast monitoring start message addressed to all the sensors 11;
receiving 203 via the sensors 11 the multicast monitoring start message;
initiating 204 via the peripheral processing and control units 14 of the sensors 11 the sampling of the continuous time signal xₘ(t) at the sampling start time t₀.

In particular, at the initial tuning instant the peripheral processing and control units 14 place and maintain the respective sensors 11 in the state of continuous reception using their respective counting and timing device 13.

In light of the initial tuning instant and of the duration of the continuous reception time window the sensors 11 are certainly in the state of continuous reception at the monitoring start instant tₐ.

Preferably, the synchronisation method 100 comprises a step in which the time difference taken by the wireless signal to reach the different sensors 11 is calculable as tₗ=δ_{distance}/c wherein δ_{distance} is the maximum difference between the distance of the sensors 11 from the central processing and control unit 12. This step is performed considering that the wireless signal propagates in air at a speed approximately equal to that of light in vacuum c.

Generally the time difference tₗ is very little compared to the other non-idealities in play. Based on the geographical area covered by the sensor system, it must still be evaluated in relation to the required synchrony requirements.

If the time difference tₗ taken by the wireless signal to reach the different sensors 11 is considered sufficiently little based on the application then it is considered that the multicast monitoring start message is approximately received at the same time by the different sensors 11.

For example, the time difference tₗ taken by the wireless signal to reach the different sensors 11 is considered sufficiently little if it is found that tₗ<<τ_{d} i.e. that tₗ is at least two orders of quantity lower than the maximum predetermined synchronisation error τ_{d} since the maximum offset between the sampling start signals must be much lower than the maximum allowed synchronisation error.

In this case, the monitoring start instant tₐ is considered to correspond to the sampling start time to and the sample sequences detected by the sensors 11 are:

$${x}_{m} ( {t}_{0} + n / ( {f}_{s} ( 1 + {δ}_{fmn} ) ) ) .$$

The sending of the multicast monitoring start message wirelessly to start sampling allows to correct the time error on the start of the sampling δₜₘ.

If δ_{fmn}>δ_{fml} the synchronisation method 100 envisages performing a second-level synchronisation 300 comprising the steps:
at an initial tuning instant equal to tₐ−T_{diff}, placing 301 the sensors 11 in a state of continuous reception for a continuous reception time window having a duration greater than 2T_{diff}+T_{cal} wherein tₐ indicates the monitoring start instant, T_{diff} indicates the maximum time offset between the counting and timing devices 13 and T_{cal} indicates the time range elapsing between two consecutive multicast messages;
at a first monitoring start instant tₐ sending 302 wirelessly via the central processing and control unit 12 a first multicast monitoring start message addressed to all sensors 11;
receiving 303 via the sensors 11 the first multicast monitoring start message;
initiating 304 via the peripheral processing and control units 14 of the sensors 11 a counting cₘ with the counting and timing device 13; such counting cₘ increases to a real oscillation frequency f_{cm} of the oscillator of the counting and timing device 13;
at a second monitoring start instant tₐ+T_{cal} sending 305 wirelessly via the central processing and control unit 12 a second multicast monitoring start message addressed to all the sensors 11;
receiving 306 via the sensors 11 the second multicast monitoring start message;
stopping and saving 307 the counting cₘ via the peripheral processing and control units 14 of the sensors 11;
calculating 308, by means of the peripheral processing and control units 14 of the sensors 11, its real oscillation frequency f_{cm} with the following expression f_{cm}=cₘ/T_{cal}=f_{c}(1+δ_{fmr}) and the oscillator real maximum tolerance δ_{fmr} with the following expression δ_{fmr}=cₘ/(T_{cal} f_{c})−1;
calculating 309, via the peripheral processing and control units 14 of the sensors 11, the value of the timing register rₘ with the following expression

$${r}_{m} = {f}_{c m} / {f}_{s} ;$$

setting 310, via the peripheral processing and control units 14 of the sensors 11, the value of the previously calculated timing register rₘ obtaining an adjusted sampling frequency fₛᵣ equal to the nominal sampling frequency fₛ.

The above-described sensor system 10 is thus configured to implement the synchronisation method 100; in detail the central processing and control unit 12 and the peripheral processing and control units 14 are configured to perform the above-described actions.

In this way, the sequences of samples are of the type xₘ(t₀+n/fₛ); it can be understood how the synchronisation method 100 according to the present invention compensated for both the time error δₜₘ on the start of the sampling and the error on the nominal sampling frequency δ_{fm}.

In practice, the correction of the time error δₜₘ is performed by sending the monitoring start multicast signal to all the sensors 11 causing the synchronised start of the sampling; the correction of the error on the nominal sampling frequency δ_{fm} is performed by means of a sort of “on the go” calibration of all the sensors 11 using a time range of known duration. One of the advantages of this procedure over a factory calibration of the oscillators is the robustness with respect to hardware aging phenomena, which can occur in an unpredictable way during the life cycle of a device, because it can be carried out immediately before each acquisition.

Furthermore, high accuracy on the time reference is only required on the central processing and control unit 12 which can also control hundreds of sensors 11 depending on the wireless protocol in use.

Using only two multicast messages to perform this type of calibration, the risk of incurring signal sending limits due to the duty cycle imposed by law is substantially zero; just think that depending on the signal sending limits (determined by the duty cycle of the specific radio channel) imposed by law it is sufficient to correctly size the amplitude of the time window T_{cal} to respect them, that is, it is sufficient to consider a time window T_{cal} large enough to overcome the duty-cycle limits.

For completeness and more clarity of discussion, the following are two examples for applying the synchronisation method 100.

Consider a first case in which m sensors 11 are applied to a civil structure with a 5 Hz vibration band, these sensors 11 being accelerometers able to connect to the LoRaWAN network. To perform a modal analysis on the civil structure, it is wished to perform synchronised samplings in a sampling window with duration T_{c}=120 s. If the structure band is 5 Hz it is sufficient to sample at a nominal sampling frequency fₛ=10 Hz to respect the Nyquist sampling theorem. Assume that the nominal maximum tolerance δ_{fmn} of the frequency of the oscillator is δ_{fmn}=10 ppm (parts per million).

The LoRaWAN protocol supports the multicast functionality and provides a class of operation (class C) in which the m-th sensor 11 is in a state of continuous reception. In addition, the LoRaWAN protocol also provides a MAC level command with which each node of the network can request the current time to the Network server to which it is connected through a gateway (the central processing and control unit 12). A nominal sampling frequency of 10 Hz corresponds to a nominal sampling period Tₛ=200 ms. Suppose that in order to perform the modal analysis it is necessary to have a predetermined tolerable synchronisation error τ_{d} at least 100 times smaller than the period of the maximum sampling frequency; in this case therefore τ_{d}=2 ms.

Assume that each sensor 11 requests via MAC command the current time every 12 hours from the central processing and control unit 12. Then considering this time and the nominal maximum tolerance δ_{fmn}, the maximum possible offset T_{diff} between the counting and timing devices 13 it results T_{diff} equal to about 500 ms; therefore, the continuous tuning window of each sensor 11 must be worth at least 1 s.

Sampling 120 seconds at 10 Hz means acquiring 1200 samples, hence k=1200. We can now obtain the limit maximum tolerance δ_{fml} of the oscillator:

$${δ}_{fm 1} = ( {τ}_{d} \cdot fs ) / ( k - {τ}_{d} fs ) ) = 16 ppm$$

The oscillator of the sensors 11 therefore has a nominal maximum tolerance equal to 10 ppm and therefore lower than the limit maximum tolerance δ_{fml}. Finally, suppose that the civil structure has the maximum size equal to 1 Km; in this case the time difference taken by the wireless signal to reach the different sensors 11 can be calculated as tₗ=δ_{distance}/c=1 Km/c=3 μs which for the exemplary case illustrated so far is quietly negligible.

In light of the above, the synchronisation method 100 is performed by implementing the first-level synchronisation 200.

Consider a second case identical to the first case in which, however, it is wished to perform synchronised samplings in a sampling window having duration T_{c}=600 s. In this case the limit maximum tolerance δ_{fml} of the oscillator is:
δ_{fml}=(τ_{d}·fₛ)/(k−τ_{d} fₛ))=3.3 ppm which is lower than the nominal maximum tolerance equal to 10 ppm of the oscillator of the sensors 11.

Therefore, the synchronisation method 100 is performed by implementing the second-level synchronisation 300.

Suppose that the central processing and control unit 12 with respect to the previous case also has a GPS connection that guarantees an accurate time reference at 1 μs. Suppose also that the oscillator of the counting and timing device 13 of the m-th sensor has an oscillation frequency f_{c}=10 MHz.

Consider the time range elapsing between two consecutive multicast messages T_{cal}=1 s.

Without taking into account the non-idealities of the oscillator, the counting cₘ would be worth c_m=1 s*10e6 MHz=10000000. Suppose that in this real case cₘ=10000050; therefore the real oscillation frequency f_{cm} would be f_{cm}=cₘ/T_{cal}=10000050 Hz and the oscillator real maximum tolerance δ_{fmr} would be δ_{fmr}=cₘ/(T_{cal} f_{c})−1=5 ppm. In this case, the value of the timing register equal to rₘ=f_{cm}/fₛ=10000050/10=1000005 is set in order to obtain the adjusted sampling frequency equal to the nominal one.

From the description made, the characteristics of the synchronisation method and of the sensor system object of the present invention are clear, as well as the relative advantages.

Finally, it is clear that the synchronisation method and the sensor system thus conceived are susceptible of numerous modifications and variations, all of which are within the scope of the invention; moreover, all the details can be replaced by technically equivalent elements. In practice, the materials used, as well as their dimensions, can be of any type according to the technical requirements.

1) A synchronisation method for a wireless sensor system for monitoring civil structures comprising the steps of:
providing and arranging a sensor system on a civil structure, said sensor system comprising:
a plurality of sensors configured to communicate wirelessly and suitable for detecting quantities useful for monitoring civil structures, each of said sensors comprising a counting and timing device and a peripheral processing and control unit associated with said counting and timing device, said counting and timing device comprising an oscillator capable of generating a clock signal at a predetermined oscillation frequency f_{c}, said peripheral processing and control unit being configured to operate on the counting and timing device to generate a clock signal having a frequency equal to a nominal sampling frequency fₛ based on a predetermined relationship between the predetermined oscillation frequency f_{c} and the nominal sampling frequency fₛ, said oscillator having a nominal maximum tolerance δ_{fmn}, said sensors being in number equal to M, each of said sensors being configured to detect and sample a continuous time signal xₘ(t) wherein m ranges from 1 to M and indicates the m-th sensor;
a central processing and control unit configured to communicate with said sensors wirelessly;
calculating the limit maximum tolerance of one of said oscillators δ_{fml} on the basis of the nominal sampling frequency fₛ, a predetermined maximum tolerable synchronisation error τ_{d} and the number of samples to be acquired in a nominal sampling window T_{c} at said nominal sampling frequency fₛ;
comparing said nominal maximum tolerance δ_{fmn} with the previously calculated limit maximum tolerance δ_{fml};
if δ_{fmn}≤δ_{fml} performing a first-synchronisation comprising the steps of:
at an initial tuning instant equal to tₐ−T_{diff}, by means of said peripheral processing and control unit, placing the sensors in a state of continuous reception for a continuous reception time window having a duration greater than 2T_{diff} wherein tₐ indicates the monitoring start instant and T_{diff} indicates the maximum time offset between said counting and timing devices;
at the monitoring start instant tₐ sending wirelessly via said central processing and control unit a single multicast monitoring start message addressed to all the sensors;
receiving via said sensors the multicast monitoring start message;
initiating via the peripheral processing and control units of the sensors the sampling of the continuous time signal xₘ(t) at a sampling start time t₀.

2) The synchronization method according to claim 1 wherein said sensors are configured to vary their sampling frequency fₛ and said peripheral processing and control unit of each of said sensors comprises a timing register rₘ whose value is variable and may be set by the peripheral processing and control unit, said counting and timing device being configured to generate from the clock signal at the oscillation frequency f_{c} a clock signal at a frequency which depends on the value of the timing register rₘ, said synchronisation method comprising the steps of:
if δ_{fmn}>δ_{fml} performing a second-level synchronisation comprising the steps of
at an initial tuning instant equal to tₐ−T_{diff}, by means of said peripheral processing and control unit, placing the sensors in a state of continuous reception for a continuous reception time window having a duration greater than 2T_{diff}+T_{cal} wherein tₐ indicates the monitoring start instant, T_{diff} indicates the maximum time offset between said counting and timing devices and T_{cal} indicates the time range elapsing between two consecutive multicast messages;
at a first monitoring start instant tₐ sending wirelessly via the central processing and control unit a first multicast monitoring start message addressed to all sensors;
receiving via said sensors the first multicast monitoring start message;
initiating via the peripheral processing and control units of the sensors a counting cₘ with the counting and timing device wherein such counting cₘ increases to a real oscillation frequency f_{cm} of the oscillator of the counting and timing device;
at a second monitoring start instant tₐ+T_{cal} sending wirelessly via the central processing and control unit a second multicast monitoring start message addressed to all the sensors;
receiving via said sensors the second multicast monitoring start message;
stopping and saving the counting cₘ via the peripheral processing and control units of the sensors;
calculating, by means of the peripheral processing and control units of the sensors, its real oscillation frequency f_{cm} with the following expression f_{cm}=cₘ/T_{cal}=f_{c}(1+δ_{fmr}) and the oscillator real maximum tolerance δ_{fmr} with the following expression δ_{fmr}=cₘ/(T_{cal} f_{c})−1;
calculating, via the peripheral processing and control units of the sensors, the value of the timing register rₘ with the following expression rₘ=f_{cm}/fₛ;
setting, via the peripheral processing and control units of the sensors, the value of the previously calculated timing register rₘ obtaining an adjusted sampling frequency fₛᵣ equal to the nominal sampling frequency fₛ.

3) The synchronisation method according to claim 1 comprising the steps of:
calculating the time difference taken by the multicast signals to reach the sensors with the following expression tₗ=δ_{distance}/c wherein δ_{distance} is the maximum difference between the distance of the sensors from the central processing and control unit;
if tₗ<<τ_{d} consider t₀=tₐ.

4) The synchronisation method according to claim 1 wherein the maximum tolerable synchronisation error τ_{d} is estimated as at least 100 times smaller than the minimum oscillation period corresponding to the maximum modal frequency of the civil structure.

5) A sensor system for monitoring civil structures configured to implement said synchronisation method according to claim 1, said sensor system comprising:
a plurality of sensors configured to communicate wirelessly and suitable for detecting quantities useful for monitoring civil structures, each of said sensors comprising a counting and timing device and a peripheral processing and control unit associated with said counting and timing device, said counting and timing device comprising an oscillator capable of generating a clock signal at a predetermined oscillation frequency f_{c}, said counting and timing device being configured to generate a clock signal having a frequency equal to a nominal sampling frequency fₛ based on a predetermined relationship between the predetermined oscillation frequency f_{c} and the nominal sampling frequency fₛ, said oscillator having a maximum nominal tolerance δ_{fmn}, said sensors being in number equal to M, each of said sensors being configured to detect and sample a continuous time signal xₘ(t) wherein m ranges from 1 to M and indicates the m-th sensor;
a central processing and control unit configured to communicate with said sensors wirelessly.

6) The sensor system according to claim 5 wherein said sensors are configured to vary their sampling frequency fₛ and said peripheral processing and control unit of each of said sensors comprises a timing register rₘ whose value is variable and may be set by the peripheral processing and control unit, said counting and timing device being configured to generate from the clock signal at the oscillation frequency f_{c} a clock signal at a frequency which depends on the value of the timing register rₘ.

7) The sensor system according to claim 4 wherein the central processing and control unit is provided with an accurate time reference.
